(19) United States
(12) Patent Application Publication
(10) Pub. No.: US 2020/0064799 A1
(43) Pub. Date: Feb. 27, 2020

(54) METHOD FOR IDENTIFYING ELETRONIC SPEED CONTROL, DEVICE, PROPULSION SYSTEM, AND MOVABLE PLATFORM

(71) Applicant: SZ DJI TECHNOLOGY CO., LTD., Shenzhen (CN)

(72) Inventors: Xi QIAO, Shenzhen (CN); Yuqi BAO, Shenzhen (CN); Zhilong ZHU, Shenzhen (CN)

(21) Appl. No.: 16/673,580

(22) Filed: Nov. 4, 2019

Related U.S. Application Data
(63) Continuation of application No. PCT/CN2017/091061, filed on Jun. 30, 2017.

(51) Int. Cl. G05B 19/042; G06F 13/40; B64C 39/02; H02P 5/00; B64C 39/08

(52) U.S. Cl. CPC G05B 19/042; G06F 13/4068; B64C 39/024; B64C 2201/14; B64C 39/028; B64C 39/08; H02P 5/00

(57) ABSTRACT

A method for identifying an electronic speed control (“ESC”) of multiple ESCs controlled through a bus is provided. The method includes receiving an initial signal transmitted from the bus, and switching to an identification setting mode. The method also includes receiving an instruction signal transmitted by a motor corresponding to the ESC, and setting an identification of the ESC currently receiving the instruction signal with an unoccupied identification value. The method further includes transmitting an identification signal carrying the unoccupied identification value to the bus.

### CROSS-REFERENCE TO RELATED APPLICATION

This application is a continuation application of International Application No. PCT/CN2017/091061, filed on Jun. 30, 2017, the entire contents of which are incorporated herein by reference.

### TECHNICAL FIELD

The present disclosure relates to the technology field of identification and, more particularly, to a method for identifying an electronic speed control, a device, a propulsion system, and a movable platform.

### BACKGROUND

Motors have been widely used in various movable platforms (e.g., robots, unmanned aerial vehicles) as propulsion sources. Typically, a movable platform may include multiple motors. For the convenience of controlling the motors, it may be desirable to identify electronic speed controls (“ESCs”) that drive the motors.

Currently, there are two primary methods for identifying the ESCs: the first method uses software installed in a host computer to identify the ESCs. The identifications of the ESCs are input manually into the host computer. Then the identification of each ESC is set through point-to-point communication between the host computer and each ESC. The second method identifies the ESCs using a human-machine interaction interface of a device. The identifications of the ESCs are manually input into the human-machine interaction interface to achieve the setting of the identification of each ESC. The above two methods are not generic. For example, if an interface for setting the ESC identification is blocked by a structure of the device, it may be necessary to disassemble the device to set the ESC identification. If the identification of the ESC is set incorrectly, it may be necessary to edit all of the identifications of the ESCs. When there is a large number of ESCs, the editing may be time consuming and inefficient.

### SUMMARY

In accordance with an aspect of the present disclosure, there is provided a method for identifying an electronic speed control (“ESC”) of multiple ESCs controlled through a bus. The method includes receiving an initial signal transmitted from the bus, and switching to an identification setting mode. The method also includes receiving an instruction signal transmitted by a motor corresponding to the ESC, and setting an identification of the ESC currently receiving the instruction signal with an unoccupied identification value. The method further includes transmitting an identification signal carrying the unoccupied identification value to the bus.

In accordance with another aspect of the present disclosure, there is also provided a device for identifying an electronic speed control (“ESC”) of multiple ESCs controlled through a bus. The device includes a memory configured to store computer-readable instructions. The device also includes a processor configured to execute the computer-readable instructions to receive an initial signal transmitted through the bus and switch to an identification setting mode. The processor is also configured to receive an instruction signal transmitted by a corresponding motor connected with the ESC, and set an identification of the ESC currently receiving the instruction signal with an unoccupied identification value. The processor is further configured to transmit an identification signal carrying the unoccupied identification value to the bus.

In accordance with another aspect of the present disclosure, there is also provided a propulsion system. The propulsion system includes a plurality of electronic speed controls connected to and controlled through a bus. The propulsion system also includes a plurality of motors connected with the electronic speed controls. The electronic speed controls are configured to control operating states of the motors. An electronic speed control of the plurality of electronic speed controls comprises a housing and a device mounted inside the housing for identifying the electronic speed control. The electronic speed control is connected with a corresponding motor of the plurality of motors. The electronic speed control includes a processor configured to receive an initial signal transmitted through the bus and switch to an identification setting mode. The processor is also configured to receive an instruction signal transmitted by the corresponding motor connected with the electronic speed control, and set an identification of the electronic speed control currently receiving the instruction signal with an unoccupied identification value. The processor is further configured to transmit an identification signal carrying the unoccupied identification value to the bus.

In accordance with another aspect of the present disclosure, there is also provided a movable platform. The movable platform includes a plurality of electronic speed controls, each connected with a corresponding motor. The movable platform also includes a central controller connected with the plurality of electronic speed controls through a bus. The central controller or an electronic speed control of the plurality of the electronic speed controls is configured to transmit an initial signal to the bus after receiving a user command for instructing the electronic speed controls to switch to an identification setting mode. The electronic speed controls are configured to switch to the identification setting mode after receiving the initial signal transmitted through the bus. An electronic speed control of the plurality of electronic speed controls is configured to receive an instruction signal transmitted by a corresponding motor, set an identification of the electronic speed control currently receiving the instruction signal with an unoccupied identification value, and transmit an identification signal carrying the unoccupied identification value to the bus.

According to the technical solutions of the present disclosure, an initial signal may be used to trigger multiple ESCs controlled by a bus to enter an identification setting mode. In the identification setting mode, a sequence of identifying the ESCs may be controlled by instruction signals received by the ESCs from corresponding motors. After an identification of an ESC is completed, an identification signal may be sent to the bus to notify other ESCs that the current identification value has been taken or occupied. As such, the identifications of the multiple ESCs are separated and distinguished from one another. Online setting of identifications of multiple ESCs may be achieved, which does not require disassembling of the ESCs. The disclosed process is simple and convenient. Further, the method for identifying the ESCs enables a user to install the ESCs in any order without having to follow the follow the order of the identifications of the ESCs provided when manufactured. After the ESCs are installed in any order, the user may control the ESCs to enter the identification setting mode to quickly identify the ESCs, such that the ESCs may drive the motors to operate. The disclosed method for identifying the ESCs is more generic than existing methods.

### BRIEF DESCRIPTION OF THE DRAWINGS

To better describe the technical solutions of the various embodiments of the present disclosure, the accompanying drawings showing the various embodiments will be briefly described. As a person of ordinary skill in the art would appreciate, the drawings show only some embodiments of the present disclosure. Without departing from the scope of the present disclosure, those having ordinary skills in the art could derive other embodiments and drawings based on the disclosed drawings without inventive efforts.

FIG. 1 is a schematic diagram of a structure of a movable platform, according to an example embodiment.

FIG. 2 is a flow chart illustrating steps performed on the ESC side in a method for identifying ESCs, according to an example embodiment.

FIG. 3 is a flow chart illustrating steps performed on the ESC side in a method for identifying ESCs, according to another example embodiment.

FIG. 4 is a flow chart illustrating steps performed on the central controller side in a method for identifying ESCs, according to an example embodiment.

FIG. 5 is a schematic diagram of a structure of a device for identifying the ESCs on the ESC side, according to an example embodiment.

FIG. 6 is a schematic diagram of a structure of a device for identifying the ESCs on the central controller side, according to an example embodiment.

FIG. 7 is a flow chart illustrating a method for identifying the ESCs, according to an example embodiment.

### LIST OF ELEMENTS

100: Central controller

101: Second processor

200: Electronic speed control (“ESC”)

201: First processor

300: Motor

### Detailed Description of the Embodiments

Technical solutions of the present disclosure will be described in detail with reference to the drawings, in which the same numbers refer to the same or similar elements unless otherwise specified. It will be appreciated that the described embodiments represent some, rather than all, of the embodiments of the present disclosure. Other embodiments conceived or derived by those having ordinary skills in the art based on the described embodiments without inventive efforts should fall within the scope of the present disclosure.

In addition, the singular forms “a,” “an,” and “the” are intended to include the plural forms as well, unless the context indicates otherwise. The terms “comprise,” “comprising,” “include,” and the like specify the presence of stated features, steps, operations, elements, and/or components but do not preclude the presence or addition of one or more other features, steps, operations, elements, components, and/or groups. The term “and/or” used herein includes any suitable combination of one or more related items listed. For example, A and/or B can mean A only, A and B, and B only. The symbol “/” means “or” between the related items separated by the symbol. The phrase “at least one of” A, B, or C encompasses all combinations of A, B, and C, such as A only, B only, C only, A and B, B and C, A and C, and A, B, and C. In this regard, A and/or B can mean at least one of A or B.

Further, when an embodiment illustrated in a drawing shows a single element, it is understood that the embodiment may include a plurality of such elements. Likewise, when an embodiment illustrated in a drawing shows a plurality of such elements, it is understood that the embodiment may include only one such element. The number of elements illustrated in the drawing is for illustration purposes only, and should not be construed as limiting the scope of the embodiment. Moreover, unless otherwise noted, the embodiments shown in the drawings are not mutually exclusive, and they may be combined in any suitable manner. For example, elements shown in one embodiment but not another embodiment may nevertheless be included in the other embodiment.

The following embodiments do not limit the sequence of execution of the steps included in the disclosed methods. The sequence of the steps may be any suitable sequence, and certain steps may be repeated.

Next, the method for identifying the ESCs, device, propulsion system, and movable platform are described in detail with reference to the accompanying drawings. Unless there is an obvious conflict, the features included in various embodiments of the present disclosure may be combined.

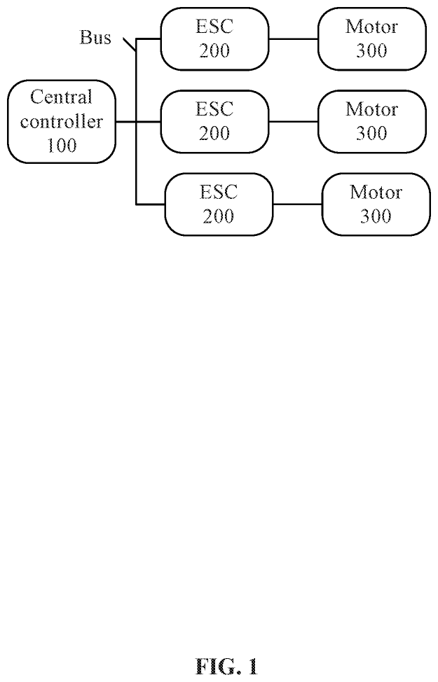

The method and device for identifying the ESCs are based on a configuration in which multiple ESCs are controlled through a bus. The multiple ESCs may be communicatively coupled together through the bus. As shown in FIG. 1, each ESC may be connected with a corresponding motor. Thus, the operation of the motors may be controlled by controlling the ESCs.

The type of the bus may be selected based on actual needs. For example, the bus may be a controller area network (“CAN”) bus, an RS485 bus, a universal asynchronous receiver/transmitter (“UART”, which is a serial data bus for asynchronous communication), a serial peripheral interface (“SPI”), an inter-integrated circuit (“I2C”), or any other suitable types.

The multiple ESCs controlled through the bus may be used in movable platforms or other devices that may need a propulsion force to operate. Using movable platforms as examples, as shown in FIG. 1, a movable platform may include a central controller and multiple ESCs. The central controller may be communicatively connected with the ESCs through a bus. Each ESC may be connected with a corresponding motor.

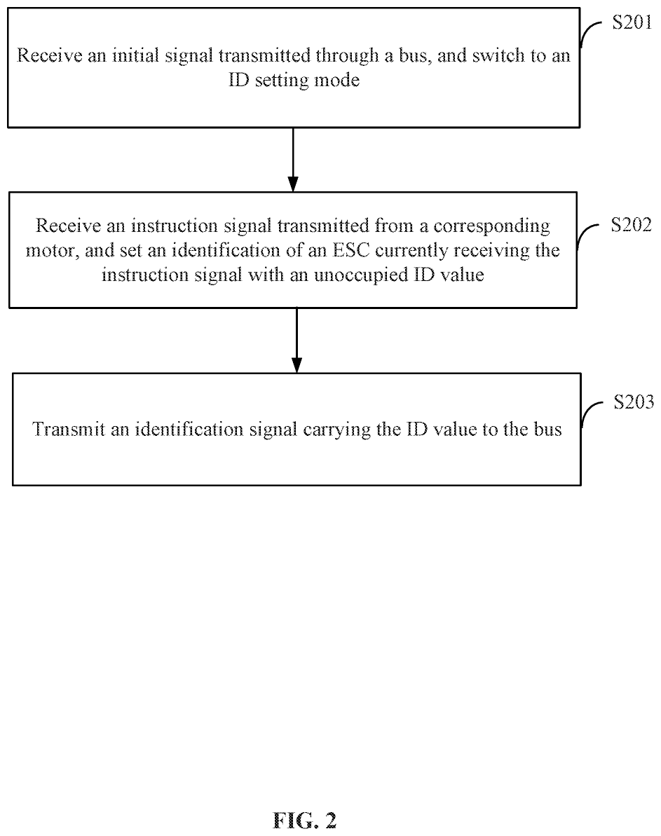

FIG. 2 is a flow chart illustrating a method for identifying ESCs on the ESC side. The entity for executing the method shown in FIG. 2 may be any ESC of the multiple ESCs.

As shown in FIG. 2, the method may include:

Step S201: receiving an initial signal transmitted through the bus, and switching to an identification setting mode;

In some embodiments, the initial signal may include a broadcasted command. For example, the bus may transmit the initial signal and each ESC connected to the bus may receive the initial signal.

In some embodiments, the initial signal may be transmitted to the bus by any ESC of the multiple ESCs, such that all of the ESCs connected to the bus may receive the initial signal and may switch to the identification setting mode after receiving the initial signal for quick identification. In some embodiments, the any ESC of the multiple ESCs may transmit the initial signal to the bus when a triggering condition is satisfied. In some embodiments, the triggering condition may be the any ESC of the multiple ESCs receiving a user command for instructing the multiple ESCs to switch to the identification setting mode. The triggering condition may be any other suitable conditions and may be flexibly set. For example, the ESCs may be provided with a triggering button. When a user presses the triggering button on an ESC, the ESC may generate the user command. In some embodiments, the ESCs may be provided with an input device. The user may input the user command through the input device. In some embodiments, the triggering condition may be other triggering conditions that may trigger an ESC of the multiple ESCs to send the initial signal to the bus. For example, the triggering condition may be an ESC of the multiple ESCs detecting that all of the ESCs have been installed.

In some embodiments, the initial signal may be transmitted by the central controller to the bus, such that the ESCs connected to the bus may receive the initial signal, and may switch to the identification setting mode after receiving the initial signal to quickly perform an identification process. In some embodiments, the central controller may send the initial signal to the bus after the triggering condition is satisfied. In some embodiments, the triggering condition may be the central controller receiving a user command for instructing the multiple ESCs to switch to the identification mode. The triggering condition may be flexibly configured. For example, in some embodiments, the central controller may be provided with a triggering button. When the user presses the triggering button, the central controller may generate the user command. In some embodiments, the central controller may be provided with a receiver to receive an input signal from a remote controller. The user may input the user command at the remote controller and the remote controller may transmit it to the receiver. In some embodiments, the triggering condition may be any other triggering condition that may trigger the central controller to send the initial signal to the bus. For example, the triggering condition may be the central controller detecting that all of the ESCs have been installed.

Step S202: receiving an instruction signal transmitted from a corresponding motor, and setting an identification of an ESC currently receiving the instruction signal with an unoccupied identification value.

In some embodiments, step S202 is performed after step S201 is executed.

In some embodiments, the instruction signal may be configured to instruct the motor to be in a specified state. The motor may provide the instruction signal to the corresponding ESC. The order (or sequence) of identifying the ESCs may be controlled based on the order in which the motors provide the instruction signals to the ESCs.

In some embodiments, the ESCs may be sensitive ESCs. The motor corresponding to the ESC may be installed with a position sensor configured to detect a state of a rotor included in the motor (e.g., a static state or a rotation state). In some embodiments, the specified state may refer to the rotor being in a rotation state. The motor may provide the instruction signal to the corresponding ESC based on the rotation state of the rotor included in the motor, thereby instructing the ESC that received the instruction signal to identify the ESC. In some embodiments, receiving the instruction signal transmitted from the corresponding motor may include: receiving the instruction signal transmitted from the position sensor mounted on the motor. In some embodiments, a user may operate a motor corresponding to an ESC to rotate. Thus, the sequence for identifying the ESCs may be flexibly set based on the user's needs. In some embodiments, other methods may be used to control the motor to rotate, and the instruction signal may be provided to the corresponding ESC through the position sensor mounted on the motor to trigger the process of identifying the ESC.

In some embodiments, the specified state may be the motor being in an operating state. For example, a triggering button connected to the corresponding ESC may be provided on each motor. A user may press the triggering button to notify the corresponding ESC that the motor connected to the ESC is in an operating state, such that the ESC may perform an identification process. This method does not require operating the motor to rotate, which is convenient and fast.

In some embodiments, an unoccupied identification value refers to an identification other than identifications of the ESCs that have performed an identification setting, or an identification other than an identification of a previous ESC that has performed an identification setting.

In some embodiments, each ESC may have a unique identification, such that each ESC can be uniquely identified by other devices. This makes it convenient for the other devices to control each ESC.

In some embodiments, at least two adjacently mounted ESCs have different identifications, such that demands on certain application scenes can be satisfied. For example, in a four-rotor unmanned aerial vehicle (“UAV”), it may be desirable to identify two pairs of diagonally installed ESCs. One pair of diagonally installed ESCs may be identified based on odd numbers, and the other pair of diagonally installed ESCs may be identified based on even numbers. This identification arrangement may satisfy the demand for controlling the diagonally installed motors to have the same rotation direction during a flight control of the UAV. For example, a flight controller may send a control command to control the motors corresponding to the ESCs that are identified using odd numbers to rotate in a first direction (e.g., a clockwise direction), and to control the motors corresponding to the ESCs that are identified using even numbers to rotate in a second direction that is opposite to the first direction (e.g., a counter-clockwise direction).

Step S203: transmitting an identification signal carrying the identification value to the bus.

In some embodiments, step S203 may be performed after “receiving an instruction signal transmitted from a corresponding motor” in step S202 is performed. In some embodiments, step S203 and “setting an identification of an ESC currently receiving the instruction signal with an unoccupied identification value” in step S202 may be executed in sequence or simultaneously.

In some embodiments, after step S203 is executed by a current ESC, the current ESC may notify other ESCs that a current ID value is an occupied identification value, such that the next ESC may set its identification value to be a next identification value that is different from the current identification value, after the next ESC receives the instruction signal from a corresponding motor.

In some embodiments, an initial signal may trigger the multiple ESCs controlled through the bus to enter an identification setting mode. In the identification setting mode, an order (or sequence) in which the ESCs are identified may be controlled based on an order in which the ESCs receive the instruction signals from the corresponding motors. After an ESC completes the identification, the ESC may transmit an identification signal to the bus to notify other ESCs that the current identification value has been occupied. In this manner, the identifications of the multiple ESCs may be distinguished from one another, thereby realizing on-line setting of the identifications of multiple ESCs. The ESCs do not need to be disassembled. The setting process is simple and fast. Using the disclosed ESC identification method, a user does not need to install the ESCs based on the order or sequence of the identifications of the ESCs assigned by the manufacturers. Instead, the user may install the ESCs in any order. After all of the ESCs are installed, the user may quickly identify each ESC in the identification setting mode to drive each motor connected with the ESC to operate. The disclosed method is strongly generic.

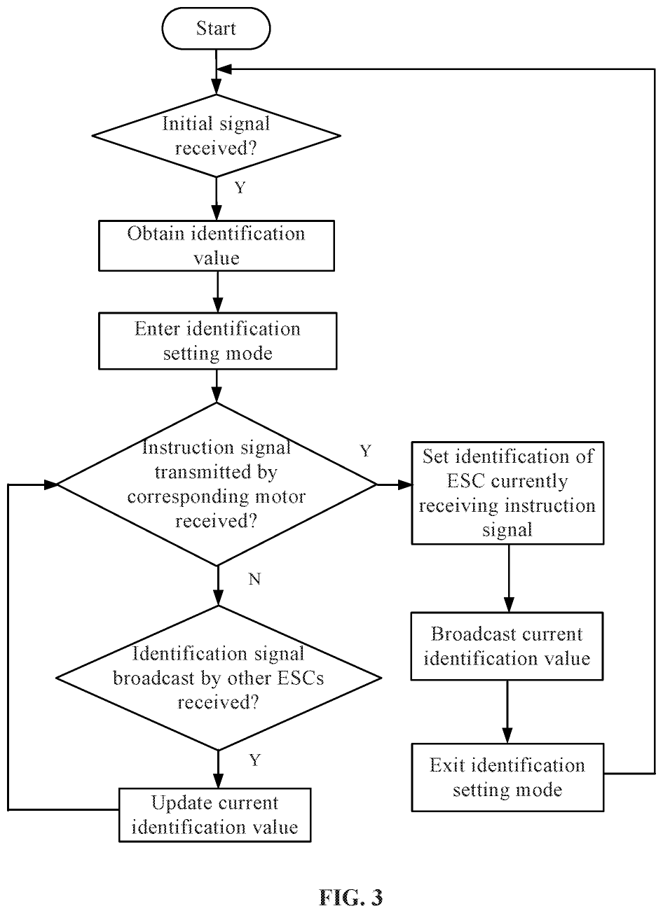

In some embodiments, as shown in FIG. 3, after transmitting an identification signal carrying the identification value to the bus, the method may also include exiting the identification setting mode. For example, after the current ESC transmits the identification signal carrying the identification value to the bus, the current ESC may exit the identification setting mode to avoid repeated identification of the current ESC (e.g., the same ESC is identified twice or more), which is a waste of resources. In the meantime, exiting the identification setting mode also enables other devices to control the current ESC. In some embodiments, the current ESC may enter an operating mode after exiting the identification setting mode. In some embodiments, the current ESC may not exit the identification setting mode after transmitting the identification signal carrying the identification value. However, when an ESC is identified using this method (i.e., in which the current ESC does not exit the identification setting mode), if the ESC again receives the instruction signal from the corresponding motor, the ESC may be identified again, which results in repeated identification of the ESC (e.g., the ESC is identified twice or more), which is a waste of resources. In some embodiments, exiting the identification setting mode may be performed simultaneously with step S203, or may be performed after step S203 is performed.

In some embodiments, in the identification setting mode, if an identification signal transmitted from other ESCs is received, the current identification value on the bus may be updated using the next identification value. In some embodiments, after the current ESC receives the identification signal transmitted from other ESCs, the current identification value on the bus may be updated using the next identification value, such that when the current ESC receives an instruction signal transmitted by a corresponding motor, the current ESC may set its identification to be a value that is different from the identification value included in the identification signal to distinguish its identification value from the identification value of an adjacent ESC. In some embodiments, after the current ESC receives the identification signal transmitted from other ESCs, and before updating the current identification value on the bus using the next identification value, the method may include: obtaining the next identification value based on the current identification value. That is, the current ESC may determine which identification values are occupied identification values based on the identification signal. The current ESC may set its identification with one of the unoccupied identification values after receiving the instruction signal transmitted by the corresponding motor. In some embodiments, the next identification value may be directly obtained from the bus. For example, after receiving the identification signal that carries an identification value, the central controller may update a current identification value on the bus using an unoccupied identification value. In some embodiments, the identification value carried by the identification signal is the same as a current identification value on the bus prior to the update.

In some embodiments, obtaining the next identification value based on the current identification value may include: changing the current identification value based on a predetermined rule and setting the next identification value using the changed current identification value. The predetermined rule may be set based on actual needs. In some embodiments, changing the current identification value based on the predetermined rule may include: increasing the current identification value based on a predetermined interval. In some embodiments, after multiple ESCs connected to the same bus have completed the identification, the identification values of the ESCs may change in an increasing trend, which may be convenient for a user to remember. In some embodiments, the predetermined interval is 1 or other suitable number. In some embodiments, changing the current identification value based on the predetermined rule may include: decreasing the current identification value based on the predetermined interval. In some embodiments, after multiple ESCs connected to the same bus have completed identification, the identification values of the ESCs may change in a decreasing trend. In some embodiments, the predetermined interval may be 1 or other suitable number, which may be convenient for a user to remember. In some embodiments, the step of obtaining the next identification value based on the current identification value may be performed based on predetermined data packages included in the central controller or the ESCs.

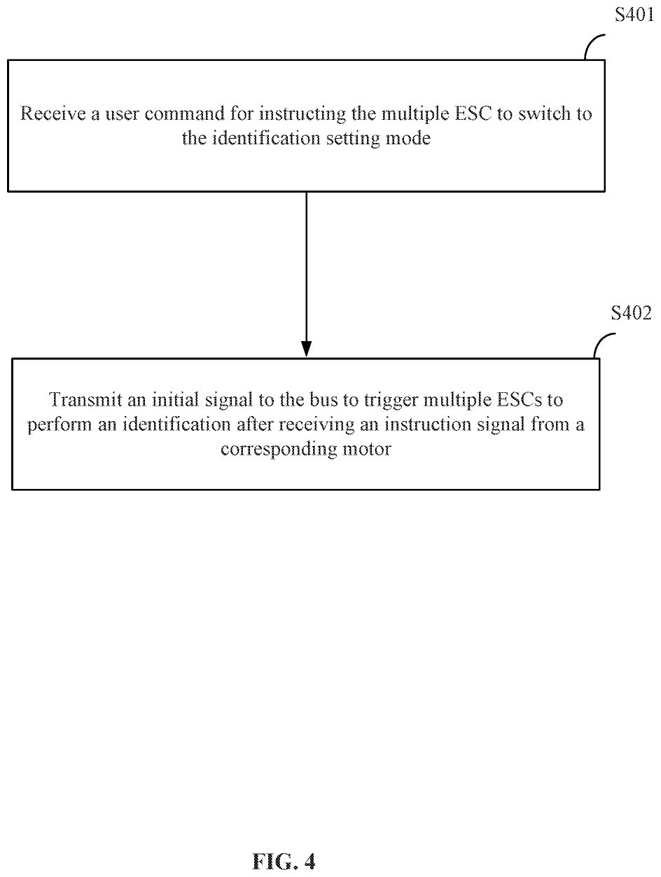

FIG. 4 is a flow chart illustrating a method for identifying an ESC on an ESC side. The method may be executed by a central controller. The central controller may include a microcontroller, such as an ARM microcontroller (Advanced Reduced Instruction Set Computing (“RISC”) Machines or RISC microcontroller), and/or an AVR microcontroller (RISC reduced instruction set high speed 8-bit single-chip microcontroller). In some embodiments, the central controller may include an ASIC (Application Specific Integrated Circuit (“ASIC”)) chip.

As shown in FIG. 4, the method may include the following steps:

Step S401: receiving a user command for instructing the multiple ESC to switch to the identification setting mode.

In some embodiments, the central controller may include a triggering button. When the user presses the triggering button, the central controller may generate the user command. In some embodiments, the central controller may include a receiver configured to receive an input signal at a remote controller side. The user may input the user command at the remote controller and the remote controller may transmit the user command to the receiver.

Step S402: transmitting an initial signal to the bus to trigger multiple ESCs to perform an identification after receiving an instruction signal from a corresponding motor.

In some embodiments, step S402 may be performed after step S401. The disclosed method may enable a user to select whether to identify ESCs based on actual needs, which is flexible.

In some embodiments, by transmitting the initial signal through the central controller to trigger multiple ESCs controlled through the bus to enter the identification setting mode, online identification of multiple ESCs may be realized. The need to disassemble the ESCs is eliminated. The setting process is simple and fast. In addition, according to the disclosed method for identifying an ESC, the user need not install the ESCs based on the sequence of the identification assigned by the manufacturer. Instead, the user may install the ESCs in any order. After all of the ESCs are installed, the user may use the identification setting mode to quickly identify the ESCs to drive the motor connected to each ESC to operate. Thus, the disclosed method is strongly generic.

In some embodiments, after the central controller receives the user command for instructing the multiple ESCs to switch to the identification setting mode, the central controller may also transmit the current identification value to the bus, such that the ESCs in the identification setting mode may timely know identification values that have not yet been identified (i.e., the identification values that have not yet been used or occupied).

In some embodiments, after the central controller transmits the initial signal to the bus, the central controller may receive the identification signal that carries an identification value transmitted through the bus. The identification signal may be transmitted by an ESC to the bus. The central controller may generate an unoccupied identification value based on the identification value carried by the identification signal, and transmit the unoccupied identification value to the bus, such that the next ESC that receives the instruction signal may obtain the unoccupied identification value directly from the bus. Thus, the disclosed method is fast and convenient. In addition, the disclosed method may avoid the situation in which two or more ESCs that need to be identified with different identification values are set with the same identification value.

In some embodiments, after the central controller transmits the initial signal to the bus, the central controller may receive an identification signal that carries an identification value transmitted through the bus. The identification signal may be transmitted to the bus by any ESC. The central controller may save the identification value, such that the central controller may transmit a command based on the identification value to control multiple ESC to operate.

In some embodiments, after all of the ESCs have been identified, the central controller may control the operations of the ESCs as follows: the central controller may transmit a control command carrying the identification of each ESC to the bus. Each of the multiple ESCs may obtain a corresponding control command based on a respective identification, and may drive a corresponding motor to operate based on the corresponding obtained control command. In some embodiments, after multiple ESCs connected to the same bus receive the control command transmitted by the central controller, the multiple ESCs may determine the control command for each of the ESCs based on the ESC identification included in the control command. Each ESC may execute the control command associated with each ESC to drive the corresponding motor to operate. The method of controlling the multiple ESCs using the central controller is not only simple, but also highly efficient.

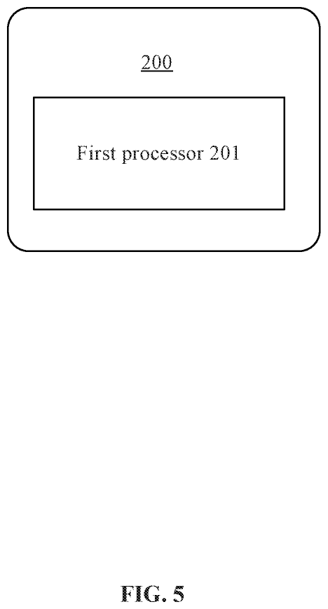

FIG. 5 is a schematic diagram of a structure of a device 200 for identifying an ESC on the ESC side. As shown in FIG. 5, the device 200 for identifying the ESC may include a first processor 201. The first processor 201 may be configured to execute the method for identifying an ESC shown in FIGS. 2-3.

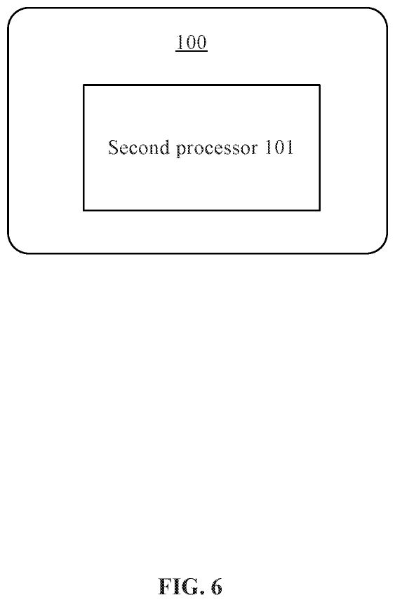

FIG. 6 is a schematic diagram of a structure of a device 100 for identifying an ESC on the central controller side. As shown in FIG. 6, the device 100 for identifying an ESC may include a second processor 101. The second processor 101 may be configured to execute the disclosed method for identifying an ESC shown in FIG. 4.

In some embodiments, the present disclosure provides a non-transitory computer-readable storage medium may be configured to store computer program code. The program may perform the methods disclosed herein for identifying the ESCs.

In some embodiments, the present disclosure provides a propulsion system including multiple ESCs and multiple motors correspondingly connected with the ESCs. The ESCs may be configured to control the operation status of the motors. Each ESC may include a housing and a device for identifying the ESC according to the method shown in FIG. 4. The device for identifying the ESC may be mounted inside the housing.

In some embodiments, as shown in FIG. 1, the present disclosure may provide a movable platform. The movable platform may include a central controller and multiple ESCs. Each ESC may be connected with a corresponding motor to drive the motor to operate. The central controller may be connected with the multiple ESCs through a bus, thereby realizing the communicative connection with the ESCs. The central controller may transmit a command to an ESC to drive the corresponding motor to operate, thereby providing the propulsion to the operation of the movable platform.

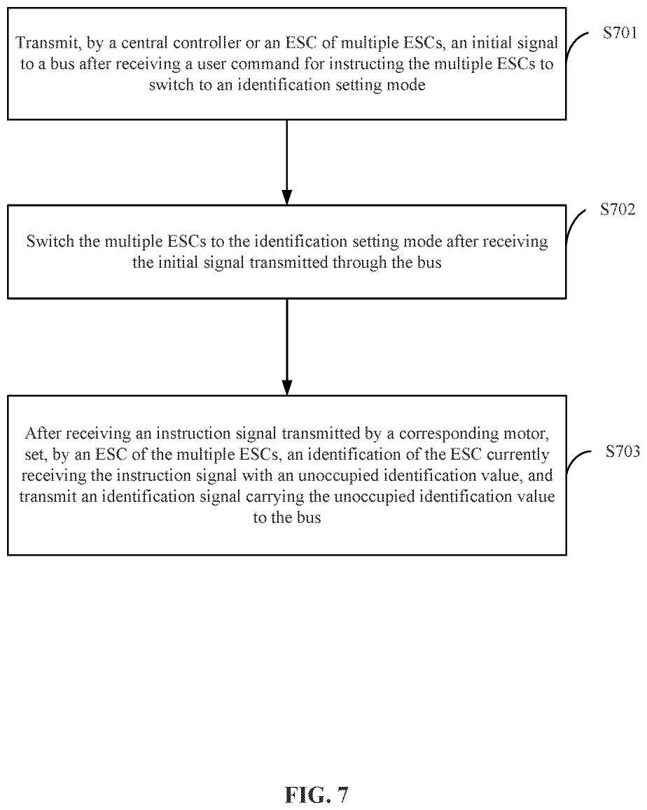

In some embodiments, as shown in FIG. 7, the movable platform may be configured to perform the following steps:

Step S701: transmitting, by the central controller or an ESC of the multiple ESCs, an initial signal to a bus after receiving a user command for instructing the multiple ESCs to switch to an identification setting mode;

Step S702: switching the multiple ESCs to the identification setting mode after receiving the initial signal transmitted through the bus;

Step S703: after receiving an instruction signal transmitted by a corresponding motor, setting, by an ESC of the multiple ESCs, an identification of the ESC currently receiving the instruction signal with an unoccupied identification value, and transmitting an identification signal carrying the unoccupied identification value to the bus.

In some embodiments, in the identification setting mode, when an ESC of the multiple ESCs receives an identification signal transmitted by other ESCs, the ESC or the central controller may update the current identification value on the bus using a next identification value.

In some embodiments, after the ESC of the multiple ESCs receives the identification signal transmitted through the bus, and before updating the current identification value on the bus using the next identification value, the ESC may obtain the next identification value based on the current identification value on the bus.

In some embodiments, after the ESC of the multiple ESCs receives the identification signal transmitted through the bus, and before updating the current identification value on the bus using the next identification value, the ESC may change the current identification value based on a predetermined rule, and may set the changed current identification value as the next identification value. The predetermined rule may include: increasing the current identification value based on a predetermined interval; or decreasing the current identification value based on the predetermined interval.

In some embodiments, the instruction signal may be configured to instruct the motor to be in a specified state. In some embodiments, the specified state may be a rotation state of a rotor of the motor. In some embodiments, the instruction signal may be transmitted by a position sensor provided on the motor that is connected with the ESC that currently receives the instruction signal, after the position sensor detects that the rotor of the motor is in a rotation state. In some embodiments, the specified state refers to the motor being in an operation state.

In some embodiments, after the ESC that currently receives the instruction signal sets its identification to be the current identification value, the ESC may exit the identification setting mode.

In some embodiments, after all of the ESCs complete the identification, the central controller may transmit a control command carrying the identifications of the ESCs to the bus. The multiple ESCs may obtain respective control commands based on their respective identifications, and may drive the corresponding motors to operate based on the obtained control commands. In some embodiments, after the multiple ESCs connected on the same bus receive control commands transmitted by the central controller, the ESCs may determine respective control commands for each ESC based on the identifications of the ESCs included in the control commands. Each ESC may execute each respective control command to drive a corresponding motor to operate. The method for controlling multiple ESCs by the central controller is simple and efficient.

In some embodiments, the bus may include at least one of a controller area network (“CAN”) bus, an RS485 bus, a universal asynchronous receiver/transmitter (“UART”, which is a serial data bus for asynchronous communication), a serial peripheral interface (“SPI”), an inter-integrated circuit (“I2C”), or any other suitable types.

In some embodiments, the central controller may transmit the current identification value to the bus after receiving a user command for instructing the multiple ESCs to switch to an identification setting mode.

In some embodiments, after the central controller transmits an initial signal to the bus, the central controller may receive an identification signal carrying an identification value transmitted through the bus. The central controller may generate an unoccupied identification value based on the identification value included in the received identification signal, and transmit the unoccupied identification value to the bus. The identification signal may be transmitted to the bus by any of the ESCs.

In some embodiments, the movable platform may be a movable vehicle (e.g., a robot), an unmanned aerial vehicle, or any other device that may include multiple ESCs controlled through a bus.

The principle for the device for identifying the ESC corresponds to the disclosed methods. Thus, descriptions of the functions performed by the device may refer to the descriptions of the disclosed methods. The embodiments described herein are intended to be illustrative only. When a unit or component is described as a separate unit or component, the separation may or may not be physical separation. The unit or component may or may not be a physical unit or component. The separate units or components may be located at a same place, or may be distributed at various nodes of a grid or network. The objective of the technical solutions may be achieved using part or all of the units disclosed herein, which may be selected based on actual needs. A person having ordinary skills in the art can understand and implement the present disclosure without any creative effort.

In the descriptions, terms such as “an embodiment,” “some embodiments,” “example embodiments,” “example,” “illustration,” or “specific example,” or “some examples,” are used to describe that the feature, structure, material, or characteristics may include at least one example or embodiment. In the descriptions, the use of the illustrative expressions does not necessarily indicate that the implementation methods or examples are the same. In addition, the specific feature, structure, material, or characteristics may be combined in any suitable manner in one or more embodiment.

A process or method shown in a flow chart or described in any other form may represent one or more module, segments, or parts of computer-executable codes for realizing specific logical functions or for executing specific steps. Other implementations of the disclosed methods or functions may also be included in the present disclosure. Steps of the processes do not necessarily have to be executed in the order shown in the flow chart or as described. Other orders or sequences, such as simultaneous execution or execution in reverse order may be adopted based on the functions to be realized. A person having ordinary skills in the art can understand that the present disclosure is not limited to the illustrative order of the steps.

The logic or steps shown in the flow chart or otherwise described in the specification may be regarded as representation of a list of computer-executable codes for realizing certain logic functions. The computer-executable codes may be embedded or encoded in a computer-readable storage medium. The computer-readable storage medium may be used by code-executing system, apparatus, or device (e.g., a computer-based system, a system having a processing device or a processor, or other systems that can read and execute codes from a code-executing system, apparatus, or device). The computer-readable medium may be used in combination with the code-executing system, apparatus, or device. In the present disclosure, the term “computer-readable medium” refers to a non-transitory device that may include, store, communicate, broadcast, or transmit computer program code for the code-executing system, apparatus, or device to execute, or may be any device that may be used with the code-executing system, apparatus, or device. The non-transitory computer-readable storage medium may include one or more of: an electrical connector having one or more wiring layouts (e.g., electronic device, a portable computer disk case (e.g., magnetic device), a random access memory (“RAM”), a read-only memory (“ROM”), an Electrically Programmable read only memory (“EPROM” or a flash memory), an optical device, or a Compact Disc-ROM (“CD-ROM”). In some embodiments, the computer-readable medium may include a paper or other suitable medium printed with a computer program. The paper or other suitable medium may be optically scanned, edited, interpreted, or processed using other methods to obtain the computer program electronically, which may be stored in a computer storage medium.

A person having ordinary skills in the art can appreciate that part or all of the above disclosed methods and processes may be implemented using related electrical hardware, computer software, firmware, or a combination thereof. In the above embodiments, multiple steps or methods may be realized using software or firmware stored in the computer-readable storage medium and executable by a suitable code-executing system. For example, if the disclosed methods and processes are implemented using hardware, the hardware may include at least one of the following: a discrete logic circuit having a logic gate circuit that may be configured to perform logic functions for digital signals, an application specific integrated circuit having suitable combinations of logic gate circuits, a programmable gate array (“PGA”), a field programmable gate array (“FPGA”), etc.

A person having ordinary skill can appreciate that all or some of the steps of the disclosed methods may be implemented through hardware that implements the computer program code. The computer program code may be stored in a computer-readable storage medium. When the computer program code is executed, the steps of the disclosed methods may be performed.

Various functional units or components may be integrated in a single processing unit, or may exist as separate physical units or components. In some embodiments, two or more units or components may be integrated in a single unit or component. The integrated unit may be realized using hardware or a combination of hardware and software. If the integrated units are realized as software functional units and sold or used as independent products, the integrated units may be stored in a non-transitory computer-readable storage medium.

The non-transitory computer-readable storage medium may be a read-only storage device, a magnetic disk, or an optical disk, etc. Although various embodiments of the present disclosure are illustrated and described, it is understood that the above described embodiments are for illustration purposes only, and are not intended to limit the scope of the present disclosure. A person having ordinary skills in the art can change, modify, replace, or vary the disclosed embodiments within the scope of the present disclosure.

Other embodiments of the present disclosure will be apparent to those skilled in the art from consideration of the specification and practice of the embodiments disclosed herein. It is intended that the specification and examples be considered as example only and not to limit the scope of the present disclosure, with a true scope and spirit of the invention being indicated by the following claims. Variations or equivalents derived from the disclosed embodiments also fall within the scope of the present disclosure.

What is claimed is:

1. A method for identifying an electronic speed control (“ESC”) of multiple ESCs controlled through a bus, comprising:
receiving an initial signal transmitted from the bus, and switching to an identification setting mode;
receiving an instruction signal transmitted by a motor corresponding to the ESC, and setting an identification of the ESC currently receiving the instruction signal with an unoccupied identification value; and
transmitting an identification signal carrying the unoccupied identification value to the bus.

2. The method of claim 1,
wherein the initial signal is transmitted to the bus by one of the multiple ESCs or by a central controller.

3. The method of claim 1, further comprising:
in the identification setting mode, updating a current identification value on the bus using a next identification value after receiving the identification signal from another ESC of the multiple ESCs.

4. The method of claim 3, wherein after receiving the identification signal from another ESC and before updating the current identification value on the bus using the next identification value, the method further comprises:
obtaining the next identification value based on the current identification value.

5. The method of claim 4, wherein obtaining the next identification value based on the current identification value comprises:
changing the current identification value based on a predetermined rule; and
setting the changed current identification value as the next identification value.

6. The method of claim 5, wherein changing the current identification value based on the predetermined rule comprises:
increasing the current identification value based on a predetermined interval; or
decreasing the current identification value based on the predetermined interval.

7. The method of claim 1, wherein the instruction signal is configured to instruct the motor to be in a specified state.

8. The method of claim 7, wherein the instruction signal is configured to instruct a rotor of the motor to be in a rotation state.

9. The method of claim 8, wherein receiving the instruction signal transmitted by the motor corresponding to the ESC comprises:
receiving the instruction signal transmitted by a position sensor mounted on the motor.

10. The method of claim 7, wherein the specified state is an operating state of the motor.

11. The method of claim 1, wherein after transmitting the identification signal carrying the identification value to the bus, the method further comprises exiting the identification setting mode.

12. A device for identifying an electronic speed control (“ESC”) of multiple ESCs controlled through a bus, comprising:
a memory configured to store computer-readable instructions; and
a processor configured to execute the computer-readable instructions to:
receive an initial signal transmitted through the bus and switch to an identification setting mode;
receive an instruction signal transmitted by a corresponding motor connected with the ESC, and set an identification of the ESC currently receiving the instruction signal with an unoccupied identification value; and
transmit an identification signal carrying the unoccupied identification value to the bus.

13. The device of claim 12, wherein
the initial signal is transmitted to the bus by one of the multiple ESCs or by a central controller.

14. The device of claim 12, wherein the processor is configured to update, in the identification setting mode, a current identification value with a next identification value after receiving an identification signal transmitted by one of the multiple ESCs.

15. The device of claim 12, wherein the instruction signal is configured to instruct the corresponding motor to be in a specified state.

16. The device of claim 12, wherein the bus includes at least one of a controller area network bus, an RS485 bus, a universal asynchronous receiver/transmitter, a serial peripheral interface, or an inter-integrated circuit.

17. The device of claim 12, wherein each ESC has a unique identification.

18. A propulsion system, comprising:
a plurality of electronic speed controls connected to and controlled through a bus; and
a plurality of motors connected with the electronic speed controls,
wherein the electronic speed controls are configured to control operating states of the motors,
wherein an electronic speed control of the plurality of electronic speed controls comprises a housing and a device mounted inside the housing for identifying the electronic speed control,
wherein the electronic speed control is connected with a corresponding motor of the plurality of motors, and
wherein the electronic speed control comprises a processor configured to:
receive an initial signal transmitted through the bus and switch to an identification setting mode;
receive an instruction signal transmitted by the corresponding motor connected with the electronic speed control, and set an identification of the electronic speed control currently receiving the instruction signal with an unoccupied identification value; and
transmit an identification signal carrying the unoccupied identification value to the bus.

19. A movable platform, comprising:
a plurality of electronic speed controls, each connected with a corresponding motor; and
a central controller connected with the plurality of electronic speed controls through a bus,
wherein the central controller or an electronic speed control of the plurality of the electronic speed controls is configured to transmit an initial signal to the bus after receiving a user command for instructing the electronic speed controls to switch to an identification setting mode,
wherein the electronic speed controls are configured to switch to the identification setting mode after receiving the initial signal transmitted through the bus, and
wherein an electronic speed control of the plurality of electronic speed controls is configured to receive an instruction signal transmitted by a corresponding motor, set an identification of the electronic speed control currently receiving the instruction signal with an unoccupied identification value, and transmit an identification signal carrying the unoccupied identification value to the bus.

20. The movable platform of claim 19, wherein in the identification setting mode, after the electronic speed control receives an identification signal transmitted from another electronic speed control, the electronic speed control or the central controller is configured to update a current identification value on the bus with a next identification value.
